(19) United States
(12) Patent Application Publication
(10) Pub. No.: US 2017/0096600 A1
(43) Pub. Date: Apr. 6, 2017

(54) GRAPHENE QUANTUM DOT-POLYMER COMPOSITES AND METHODS OF MAKING THE SAME

(71) Applicants: James M. Tour, Bellaire, TX (US); Anton Kovalchuk, Houston, TX (US); Xiang Changsheng, Houston, TX (US)

(72) Inventors: James M. Tour, Bellaire, TX (US); Anton Kovalchuk, Houston, TX (US); Xiang Changsheng, Houston, TX (US)

(73) Assignee: William Marsh Rice University, Houston, TX (US)

(21) Appl. No.: 15/314,224

(22) PCT Filed: May 22, 2015
(86) PCT No.: PCT/US2015/032209

§ 371 Date: Nov. 28, 2016

Related U.S. Application Data
(60) Provisional application No. 62/002,982, filed on May 26, 2014.

(51) Int. Cl. C09K 11/02; C08J 5/18; C08K 3/04; C08K 9/04; C09K 11/65; C09K 11/06

(52) U.S. Cl. CPC C09K 11/025; C09K 11/65; C09K 11/06; C08K 3/04; C08K 9/04; C08J 5/18; C09K 2211/10; B82Y 40/00

(57) ABSTRACT

Various embodiments of the present disclosure pertain to methods of forming polymer composites that include polymers and graphene quantum dots. The methods occur by mixing a polymer component (e.g., polymers, polymer precursors and combinations thereof) with graphene quantum dots. In some embodiments, the polymers are in the form of a polymer matrix, and the graphene quantum dots are homogenously dispersed within the polymer matrix. In some embodiments, the graphene quantum dots include, without limitation, coal-derived graphene quantum dots, coke-derived graphene quantum dots, unfunctionalized graphene quantum dots, functionalized graphene quantum dots, pristine graphene quantum dots, and combinations thereof. Additional embodiments of the present disclosure pertain to polymer composites that are formed by the methods of the present disclosure. In some embodiments, the polymer composites of the present disclosure are fluorescent and optically transparent. In some embodiments, the polymer composites of the present disclosure are in the form of a film.

### CROSS-REFERENCE TO RELATED APPLICATIONS

This application claims priority to U.S. Provisional Patent Application No. 62/002,982, filed on May 26, 2014. In addition, this application is related to International Patent Application No. PCT/US2014/036604, filed on May 2, 2014, which claims priority to U.S. Provisional Patent Application No. 61/818,800, filed on May 2, 2013. The entirety of each of the aforementioned applications is incorporated herein by reference.

### STATEMENT REGARDING FEDERALLY SPONSORED RESEARCH

This invention was made with government support under Grant No. N00014-09-1-1066, awarded by the U.S. Department of Defense; Grant No. FA9550-12-1-0035, awarded by the U.S. Department of Defense; and Grant No. FA9550-09-1-0581, awarded by the U.S. Department of Defense. The government has certain rights in the invention.

### BACKGROUND

Current methods of making quantum dot-polymer composites have limitations in terms of scalability, cost-effectiveness, biodegradability, and photoluminescent properties. Various aspects of the present disclosure address these limitations.

### SUMMARY

In some embodiments, the present disclosure pertains to methods of forming polymer composites that include polymers and graphene quantum dots. In some embodiments, the methods include mixing a polymer component with graphene quantum dots. In some embodiments, the polymer component includes, without limitation, polymers, polymer precursors and combinations thereof.

In some embodiments, the mixing occurs in the absence of a solvent. In some embodiments, the mixing occurs in a solvent. In some embodiments, the method also includes a step of removing at least a portion of the solvent. In some embodiments, the mixing results in the association of the graphene quantum dots with the polymer component.

In some embodiments, the polymer component includes polymers. In some embodiments, the polymers include water soluble polymers, water insoluble polymers, and combinations thereof. In some embodiments, the polymers include, without limitation, vinyl polymers, condensation polymers, chain-growth polymers, step-growth polymers, polyacrylamides, polyacrylates, polystyrene, polybutadiene, polyacrylonitrile, polysaccharides, polyacrylic acid, polyesters, polyamides, polyurethanes, polyimides, nylons, polyvinyl alcohol, polyethylene oxide, polypropylene oxides, polyethylene glycol, poly(ethylene terephthalate), poly(methyl methacrylate), derivatives thereof, and combinations thereof.

In some embodiments, the polymers are in the form of a polymer matrix. In some embodiments, the graphene quantum dots are homogenously dispersed within the polymer matrix.

In some embodiments, the polymer component includes polymer precursors. In some embodiments, the polymer precursors polymerize to form polymers. In some embodiments, the polymer precursors polymerize during the mixing step. In some embodiments, the methods of the present disclosure also include a step of polymerizing the polymer precursors.

In some embodiments, the graphene quantum dots include, without limitation, unfunctionalized graphene quantum dots, functionalized graphene quantum dots, pristine graphene quantum dots, and combinations thereof. In some embodiments, the graphene quantum dots include functionalized graphene quantum dots, such as edge-functionalized graphene quantum dots. In some embodiments, the graphene quantum dots include pristine graphene quantum dots. In some embodiments, the graphene quantum dots include, without limitation, coal-derived graphene quantum dots, coke-derived graphene quantum dots, and combinations thereof.

Additional embodiments of the present disclosure pertain to polymer composites that are formed by the methods of the present disclosure. In some embodiments, the polymer composites include a polymer and graphene quantum dots. In some embodiments, the graphene quantum dots are associated with the polymer. In some embodiments, graphene quantum dots constitute from about 1% to about 15% of the polymer composite by weight. In some embodiments, graphene quantum dots constitute from about 1% to about 5% of the polymer composite by weight.

In some embodiments, the polymer composites of the present disclosure are fluorescent. In some embodiments, the polymer composites of the present disclosure are optically transparent. In some embodiments, the polymer composites of the present disclosure are in the form of a film.

### DESCRIPTION OF THE FIGURES

FIG. 1 provides a scheme of a method of preparing polymer composites that contain graphene quantum dots (GQDs).

FIG. 2 provides Fourier transform infrared (FT-IR) spectra for the following compositions: neat polyvinyl alcohol (PVA) (line 1); composite of PVA and graphene quantum dots (GQDs) with 3 wt % GQDs (line 2); composite of PVA and GQDs with 15 wt % GQDs (line 3); composite of PVA and GQDs with 20 wt % GQDs (line 4); and GQDs alone (line 5).

FIG. 3 provides transmission electron microscopy (TEM) and high resolution TEM (HR-TEM) images of the following compositions: coal-derived GQDs (FIG. 3A, TEM); coal-derived GQDs (FIG. 3B, HR-TEM); composite of PVA and GQDs with 1 wt % GQDs (FIG. 3C, TEM); composite of PVA and GQDs with 3 wt % GQDs (FIG. 3D, TEM); composite of PVA and GQDs with 5 wt % GQDs (FIG. 3E, TEM); and composite of PVA and GQDs with 10 wt % GQDs (FIG. 3F, TEM).

FIG. 4 provides UV/vis spectra for the following compositions: neat PVA film (line a); composite of PVA and GQDs with 3 wt % GQDs (line b); composite of PVA and GQDs with 5 wt % GQDs (line c); composite of PVA and GQDs with 15 wt % GQDs (line d); and composite of PVA and GQDs with 25 wt % GQDs (line e).

FIG. 5 provides a graph of optical transparency (measured at 550 nm) as a function of GQD concentration in PVA/GQD composite films.

FIG. 6 provides differential scanning calorimetry (DSC) thermograms (1^{st} heating cycles) for the following compositions: neat PVA film (line a); composite of PVA and GQDs with 3 wt % GQDs (line b); composite of PVA and GQDs with 7 wt % GQDs (line c); composite of PVA and GQDs with 15 wt % GQDs (line d); composite of PVA and GQDs with 20 wt % GQDs (line e); and composite of PVA and GQDs with 25 wt % GQDs (line f).

FIG. 7 provides thermogravimetric analysis (TGA) profiles for various PVA and PVA/GQD composite films in air.

FIG. 8 shows a photograph demonstrating fluorescence emitted by a dilute aqueous solution of GQDs (0.125 mg/mL) under UV light.

FIG. 9 shows a photoluminescence spectrum of a dilute aqueous solution of GQDs (0.125 mg/mL).

FIG. 10 provides a photograph of the following films under UV lamp: neat PVA film (image a); composite of PVA and GQDs with 3 wt % GQDs (image b); composite of PVA and GQDs with 5 wt % GQDs (image c); and composite of PVA and GQDs with 10 wt % GQDs (image d). The width of each film is about 25 mm.

FIG. 11 provides photoluminescence spectra of the following films: neat PVA film (line 1); composite of PVA and GQDs with 1 wt % GQDs (line 2); composite of PVA and GQDs with 2 wt % GQDs (line 3); composite of PVA and GQDs with 3 wt % GQDs (line 4); composite of PVA and GQDs with 5 wt % GQDs (line 5); composite of PVA and GQDs with 10 wt % GQDs (line 6); composite of PVA and GQDs with 15 wt % GQDs (line 7); and composite of PVA and GQDs with 25 wt % GQDs (line 8).

FIG. 12 provides a graph of the photoluminescence peak intensity at 430 nm wavelength for PVA/GQD composite films as a function of GQD concentration

FIG. 13 shows images of polymer composites that were formed by mixing polymer precursors with GQDs. The images were taken while the polymer composites were exposed to UV irradiation. FIG. 13A is an image of a polystyrene/GQD composite that was formed by polymerizing styrene monomers in the presence of tetradecylated graphene quantum dots derived from anthracite (C₁₄-aGQDs). FIG. 13B is an image of a poly(methyl methacrylate)/GQD composite that was formed by polymerizing methyl methacrylate in the presence of C₁₄-aGQDs.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Due to their unique size-dependent electro-optical properties, colloidal semiconductor quantum dots (QDs) have numerous potential applications in solar cells, light emitting diodes, bioimaging, electronic displays and other optoelectronic devices, and have thus been of significant research interest. For instance, the incorporation of QDs in a transparent polymer matrix is one of the main approaches for their utilization in numerous photonic and optoelectronic applications and integration in real devices. Besides playing the role of the matrix, polymers provide mechanical and chemical stability to the nanocomposite. Additionally, the presence of polymers may prevent QD agglomeration, thereby decreasing their emission properties.

However, due to the high market cost of inorganic QDs (e.g., on the order of thousands of US dollars per gram), their industrial use has been slow and limited. Furthermore, inorganic QDs demonstrate limited biodegradability and photoluminescent properties.

As such, a need exists for the development of more effective methods of making quantum dot-containing polymer composites. A need also exists for quantum dot-polymer composites with improved optical properties. Various aspects of the present disclosure address these needs.

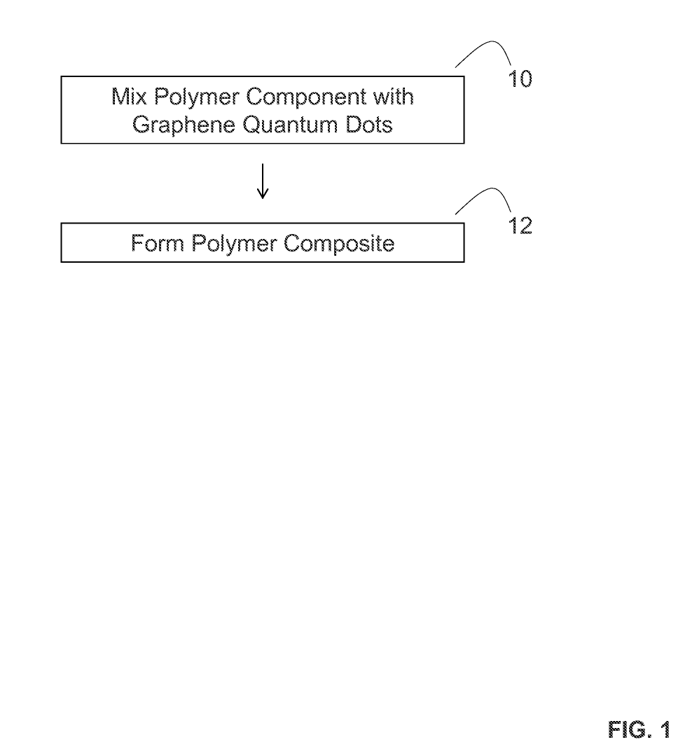

In some embodiments, the present disclosure pertains to methods of forming a polymer composite that includes polymers and graphene quantum dots. In some embodiments that are illustrated in FIG. 1, the methods of the present disclosure include mixing a polymer component with graphene quantum dots (step 10) to form the polymer composite (step 12). In some embodiments, the polymer component includes, without limitation, polymers, polymer precursors, and combinations thereof. In some embodiments, the mixing step results in the association of the graphene quantum dots with the polymer component (e.g., polymers). In some embodiments where the polymer component includes polymer precursors, the mixing step can result in the polymerization of the polymer precursors. In some embodiments, the methods of the present disclosure also include a step of tuning the emission wavelength of the polymer composites.

Further embodiments of the present disclosure pertain to polymer composites that are formed by the methods of the present disclosure. In some embodiments, the polymer composites of the present disclosure include a polymer and graphene quantum dots.

As set forth in more detail herein, various methods may be utilized to mix various types of polymer components with various types of graphene quantum dots to result in the formation of various types of polymer composites. Moreover, various methods may be utilized to tune the emission wavelength of the polymer composites.

Mixing of Polymer Components with Graphene Quantum Dots

The present disclosure may utilize various methods of mixing polymer components with graphene quantum dots. For instance, in some embodiments, the mixing step can include, without limitation, stirring, magnetic stirring, sonication, agitation, centrifugation, blending, extruding, masticating, heating, solution casting, molding, pressing, and combinations thereof.

In some embodiments, the mixing step includes heating. In some embodiments, heating occurs at temperatures that range from about 50° C. to about 500° C. In some embodiments, heating occurs at temperatures that range from about 50° C. to about 100° C. In some embodiments, heating occurs at a temperature of about 80° C.

In some embodiments, the mixing step includes sonication. In some embodiments, the sonication occurs in a sonication bath. In some embodiments, the mixing step includes solution casting.

In some embodiments, the mixing step includes blending. In some embodiments, the mixing step includes mechanical blending. In some embodiments, the mechanical blending may utilize a mechanical system, such as a twin screw blender, an extruding system or a hot press system.

The mixing of polymer components with graphene quantum dots can occur for various periods of time. For instance, in some embodiments, the mixing step can occur from about 5 seconds to about 48 hours. In some embodiments, the mixing step can occur from about 1 minute to about 24 hours. In some embodiments, the mixing step can occur from about 5 minutes to about 12 hours. In some embodiments, the mixing step can occur for about 10 minutes. In some embodiments, the mixing step can occur for about 24 hours.

Solvent-Based Mixing Methods

In some embodiments, polymer components and graphene quantum dots can be mixed in the presence of various solvents. For instance, in some embodiments, the solvent is an aqueous solvent. In some embodiments, the solvent includes, without limitation, acetic acid, butanol, isopropanol, ethanol, methanol, formic acid, water, sulfuric acid, N-methly pyrrolidone, dimethylformamide, dimethylsulfoxide, toluene, chlorobenzene, 1,2-dichlorbenzene, tetrahydrofuran, dichloromethane, chloroform, and combinations thereof. In some embodiments, the solvent is water. In some embodiments where graphene quantum dots are functionalized (e.g., alkyl- or aryl-functionalized graphene quantum dots, as described in more detail herein), the solvents can include, without limitation, toluene, chlorobenzene, 1,2-dichlorbenzene, tetrahydrofuran (THF), dichloromethane, chloroform, and combinations thereof. The use of additional solvents can also be envisioned.

Removal of Solvents

In some embodiments, at least portion of a solvent may be removed from a reaction mixture after the mixing of polymer components with graphene quantum dots. Various methods may be utilized to remove solvents from reaction mixtures. For instance, in some embodiments, a solvent is removed from a reaction mixture by drying, evaporation, filtration, decanting, centrifugation, heating, and combinations thereof.

In some embodiments, solvent removal occurs in a vacuum. In some embodiments, heat generated from a mixing step (e.g., heat generated from a mechanical blender) can be used to remove the solvent from a reaction mixture (e.g., by evaporation). In some embodiments, a mechanical mixing step may be utilized to remove the solvent from a reaction mixture. For instance, in some embodiments, the reaction mixture may be pressed in a polymer mold and heated to remove the solvent. Additional solvent removal methods can also be envisioned.

In some embodiments, the entire amount of the solvent is removed from a reaction mixture (i.e., 100% of the solvent). In some embodiments, a substantial amount of the solvent is removed from a reaction mixture (e.g., from about 80% to about 99% of the solvent). In some embodiments, the removal of a solvent from a reaction mixture results in the formation of the polymer composites of the present disclosure.

Solvent-Free Mixing Methods

In some embodiments, polymer components and graphene quantum dots can be mixed in the absence of solvents. Various solvent-free methods may be utilized to mix polymer components and graphene quantum dots. Such methods were described previously. For instance, in some embodiments, graphene quantum dots may be mixed with polymer components in the absence of solvents by mechanical blending. In some embodiments, the mechanical blending may utilize a mechanical system, such as a twin screw blender, an extruding system, or a hot press system.

In some embodiments, the graphene quantum dots and polymer components may be in solid states, gaseous states, liquid states or combinations of such states during solvent-free mixing. For instance, in some embodiments, the polymer components may be in a liquid state (e.g., a molten state) during mixing.

In some embodiments, graphene quantum dots may be mixed with molten polymer components. In some embodiments, the molten polymer components may be mixed with graphene quantum dots by blending, such as mechanical blending in a twin screw blender or extruding system.

Polymerization of Polymer Precursors

In some embodiments where polymer components include polymer precursors, polymer precursors can polymerize to form the polymers of the present disclosure. As set forth in more detail herein, the polymer precursors of the present disclosure can polymerize in various manners.

In some embodiments, the polymer precursors of the present disclosure polymerize during a mixing step. In some embodiments, the methods of the present disclosure include an additional step of polymerizing the polymer precursors. For instance, in some embodiments, the polymerizing occurs by heating the polymer precursors. In some embodiments, the polymerizing occurs by exposing the polymer precursors to a polymerizing agent. In some embodiments, the polymerizing occurs by adding a polymerizing agent to a reaction mixture. In some embodiments, the polymerizing agent includes, without limitation, azobis(isobutyronitrile) (AIBN), 1,1′-azobis(cyclohexanecarbonitrile), di-tert-butyl peroxide, benzoyl peroxide, methyl ethyl ketone peroxide, peroxydisulfate salts, copper chelates, alkyl or aryl lithium reagents, alkyl or aryl sodium reagents, alkyl or aryl potassium reagents, and combinations thereof. Additional polymerization methods can also be envisioned.

Polymer precursors can polymerize in various manners. For instance, in some embodiments, the polymer precursors of the present disclosure can be polymerized by anionic polymerization, cationic polymerization, metal-catalyzed polymerization, living polymerization, radical polymerization, atom transfer radical polymerization (ATRP), metathesis, and combinations thereof.

Polymer Components

The methods of the present disclosure can utilize various types of polymer components. For instance, in some embodiments, the polymer components of the present disclosure include, without limitation, polymers, polymer precursors and combinations thereof. As such, the polymer composites of the present disclosure can include various types of polymers that are derived from the polymer components.

Polymers

In some embodiments, the polymer components of the present disclosure include polymers. In some embodiments, the polymers of the present disclosure include water soluble polymers. In some embodiments, the polymers of the present disclosure include water insoluble polymers. In some embodiments, the polymers of the present disclosure include, without limitation, vinyl polymers, condensation polymers, chain-growth polymers, step-growth polymers, polyacrylamides, polyacrylates, polystyrene, polybutadiene, polyacrylonitrile, polysaccharides, polyacrylic acid, polyesters, polyamides, polyurethanes, polyimides, nylons, polyvinyl alcohol, polyethylene oxide, polypropylene oxides, polyethylene glycol, poly(ethylene terephthalate), poly(methyl methacrylate), derivatives thereof, and combinations thereof.

In some embodiments, the polymers of the present disclosure include polysaccharides. In some embodiments, the polysaccharides include, without limitation, cellulose, starch, chitosan, chitin, glycogen, derivatives thereof, and combinations thereof.

In some embodiments, the polymers of the present disclosure include polyesters, polyamides, and combinations thereof. In some embodiments, the polyesters and polyamides include methacroyl esters and amides (e.g., methacroyl esters and amides that bear hydrophilic pendants such as CH₂CH₂OH and other similar compounds).

In some embodiments, the polymers of the present disclosure include water insoluble polymers. In some embodiments, the water insoluble polymers include, without limitation, polyurethanes, polyimides, nylons and combinations thereof.

The polymers of the present disclosure can be in various forms. For instance, in some embodiments, the polymers of the present disclosure can be in the form of a polymer matrix. In some embodiments, the polymers of the present disclosure can be in the form of a polymer film. Additional types and forms of polymers can also be envisioned.

Polymer Precursors

In some embodiments, the polymer components of the present disclosure include polymer precursors. In some embodiments, the polymer precursors include, without limitation, vinyl monomers, acrylamides, acrylates, styrene, butadiene, acrylonitrile, saccharides, acrylic acid, esters, amides, urethanes, imides, vinyl alcohol, ethylene oxide, propylene oxide, ethylene glycol, ethylene terephthalate, methyl methacrylate, derivatives thereof, and combinations thereof. In some embodiments, the polymer precursors of the present disclosure include styrene. In some embodiments, the polymer precursors of the present disclosure include acrylates, such as methyl methacrylates.

Polymer Component States

The polymer components of the present disclosure may be in various states when they are mixed with graphene quantum dots. For instance, in some embodiments, the polymer components of the present disclosure may be in the form of a powder. In some embodiments, the polymer components of the present disclosure may be in the form of a pellet. In some embodiments, the polymer components of the present disclosure may be in a liquid state (e.g., a molten state).

Graphene Quantum Dots

The methods of the present disclosure can utilize various types of graphene quantum dots. As such, the polymer composites of the present disclosure can include various types of graphene quantum dots.

In some embodiments, the graphene quantum dots of the present disclosure include, without limitation, unfunctionalized graphene quantum dots, functionalized graphene quantum dots, pristine graphene quantum dots, and combinations thereof. In some embodiments, the graphene quantum dots of the present disclosure include functionalized graphene quantum dots. In some embodiments, the functionalized graphene quantum dots of the present disclosure are functionalized with one or more functional groups. In some embodiments, the functional groups include, without limitation, oxygen groups, carboxyl groups, carbonyl groups, amorphous carbon, hydroxyl groups, alkyl groups, aryl groups, esters, amines, amides, polymers, poly(propylene oxide), and combinations thereof.

In some embodiments, the graphene quantum dots of the present disclosure include functionalized graphene quantum dots that are functionalized with one or more alkyl groups. In some embodiments, the alkyl groups include, without limitation, methyl groups, ethyl groups, propyl groups, butyl groups, pentyl groups, hexyl groups, heptyl groups, octyl groups, nonyl groups, decyl groups, undecyl groups, and combinations thereof. In some embodiments, the alkyl groups include octyl groups, such as octylamine.

In some embodiments, the graphene quantum dots of the present disclosure can be functionalized with one or more polymer precursors (as previously described). For instance, in some embodiments, the graphene quantum dots may be functionalized with one or more monomers (e.g., vinyl monomers).

In some embodiments, the graphene quantum dots of the present disclosure may be functionalized with polymer precursors that polymerize to form polymer-functionalized graphene quantum dots. For instance, in some embodiments, the graphene quantum dots of the present disclosure can be edge functionalized with vinyl monomers that polymerize to form edge-functionalized polyvinyl addends.

In some embodiments, the graphene quantum dots of the present disclosure include functionalized graphene quantum dots that are functionalized with one or more hydrophilic functional groups. In some embodiments, the hydrophilic functional groups include, without limitation, carboxyl groups, carbonyl groups, hydroxyl groups, hydroxy alkyl groups (e.g., CH₂CH₂OH), poly(ethylene glycol), poly(vinyl alcohol), poly(acrylic acid), and combinations thereof.

In some embodiments, the graphene quantum dots of the present disclosure include functionalized graphene quantum dots that are functionalized with one or more hydrophobic functional groups. In some embodiments, the hydrophobic functional groups include, without limitation, alkyl groups, aryl groups, and combinations thereof. In some embodiments, the hydrophobic functional groups include one or more alkyl or aryl amides.

In some embodiments, the graphene quantum dots of the present disclosure include edge-functionalized graphene quantum dots. In some embodiments, the edge-functionalized graphene quantum dots include one or more hydrophobic functional groups, as previously described. In some embodiments, the edge-functionalized graphene quantum dots include one or more hydrophilic functional groups, as also previously described. In some embodiments, the edge-functionalized graphene quantum dots include one or more oxygen addends on their edges. In some embodiments, the edge-functionalized graphene quantum dots include one or more amorphous carbon addends on their edges.

In some embodiments, the graphene quantum dots of the present disclosure are edge-functionalized with one or more alkyl or aryl groups, such as alky or aryl amides. In some embodiments, the edge-functionalization of graphene quantum dots with alkyl or aryl groups occurs by the reaction of alkyl or aryl amides with carboxylic acids on the edges of the graphene quantum dots. In some embodiments, the edge-functionalization will convert the graphene quantum dots from being water soluble to being water insoluble (i.e., organic soluble). In some embodiments, the water insoluble graphene quantum dots are mixed with hydrophobic polymers to form the polymer composites of the present disclosure. Additional embodiments that pertain to edge-functionalized graphene quantum dots are disclosed in ACS Appl. Mater. Interfaces, 2015, 7 (16), pp 8615-8621.

In some embodiments, the graphene quantum dots of the present disclosure include pristine graphene quantum dots. In some embodiments, the pristine graphene quantum dots include graphene quantum dots that remain untreated after synthesis. In some embodiments, the pristine graphene quantum dots include graphene quantum dots that lack any additional surface modifications after synthesis.

The graphene quantum dots of the present disclosure can be derived from various sources. For instance, in some embodiments, the graphene quantum dots of the present disclosure include, without limitation, coal-derived graphene quantum dots, coke-derived graphene quantum dots, and combinations thereof. In some embodiments, the graphene quantum dots of the present disclosure include coke-derived graphene quantum dots. In some embodiment, the graphene quantum dots of the present disclosure include coal-derived graphene quantum dots. In some embodiments, the coal includes, without limitation, anthracite, bituminous coal, sub-bituminous coal, metamorphically altered bituminous coal, asphaltenes, asphalt, peat, lignite, steam coal, petrified oil, carbon black, activated carbon, and combinations thereof. In some embodiments, the coal includes bituminous coal.

The graphene quantum dots of the present disclosure can have various diameters. For instance, in some embodiments, the graphene quantum dots of the present disclosure have diameters that range from about 1 nm to about 100 nm. In some embodiments, the graphene quantum dots of the present disclosure have diameters that range from about 1 nm to about 50 nm. In some embodiments, the graphene quantum dots of the present disclosure have diameters that range from about 15 nm to about 50 nm. In some embodiments, the graphene quantum dots of the present disclosure have diameters that range from about 15 nm to about 20 nm. In some embodiments, the graphene quantum dots of the present disclosure have diameters that range from about 1 nm to about 10 nm. In some embodiments, the graphene quantum dots of the present disclosure have diameters that range from about 1 nm to about 5 nm.

The graphene quantum dots of the present disclosure can also have various structures. For instance, in some embodiments, the graphene quantum dots of the present disclosure have a crystalline structure. In some embodiments, the graphene quantum dots of the present disclosure have a crystalline hexagonal structure. In some embodiments, the graphene quantum dots of the present disclosure have a single layer. In some embodiments, the graphene quantum dots of the present disclosure have multiple layers. In some embodiments, the graphene quantum dots of the present disclosure have from about two layers to about four layers.

The graphene quantum dots of the present disclosure can also have various quantum yields. For instance, in some embodiments, the graphene quantum dots of the present disclosure have a quantum yield ranging from about 0.5% to about 25%. In some embodiments, the graphene quantum dots of the present disclosure have a quantum yield ranging from about 1% to about 10%. In some embodiments, the graphene quantum dots of the present disclosure have a quantum yield ranging from about 1% to about 5%. In some embodiments, the graphene quantum dots of the present disclosure have a quantum yield of more than about 10%. In some embodiments, the graphene quantum dots of the present disclosure have a quantum yield of about 1%.

The graphene quantum dots of the present disclosure may be in various states when they are mixed with polymers. For instance, in some embodiments, the graphene quantum dots of the present disclosure may be in the form of a powder. In some embodiments, the graphene quantum dots of the present disclosure may be in the form of a pellet. In some embodiments, the graphene quantum dots of the present disclosure may be in a liquid state (e.g., a molten state).

The use of additional graphene quantum dots in the polymer composites of the present disclosure can also be envisioned. For instance, additional graphene quantum dots that may be suitable for the present disclosure are disclosed in Applicants' co-pending International Patent Application No. PCT/US2014/036604. Additional graphene quantum dots that may be suitable for the present disclosure are also disclosed in the following references by Applicants: ACS Appl. Mater. Interfaces 2015, 7, 7041-7048; and Nature Commun. 2013, 4:2943, 1-6.

Formation of Graphene Quantum Dots

In some embodiments, the methods of the present disclosure can also include a step of forming graphene quantum dots. For instance, in some embodiments, the methods of the present disclosure can include a step of forming graphene quantum dots prior to a step of mixing polymers with the formed graphene quantum dots.

Various methods may be utilized to form graphene quantum dots. For instance, in some embodiments, the step of forming the graphene quantum dots can include exposing a carbon source to an oxidant to result in the formation of graphene quantum dots. In some embodiments, the carbon source includes, without limitation, coal, coke and combinations thereof.

In some embodiments, the oxidant includes an acid. In some embodiments, the acid includes, without limitation, sulfuric acid, nitric acid, phosphoric acid, hypophosphorous acid, fuming sulfuric acid, hydrochloric acid, oleum, chlorosulfonic acid, and combinations thereof. In some embodiments, the oxidant is nitric acid. In some embodiments, the oxidant only consists of a single acid, such as nitric acid.

In some embodiments, the oxidant includes, without limitation, potassium permanganate, sodium permanganate, hypophosphorous acid, nitric acid, sulfuric acid, hydrogen peroxide, and combinations thereof. In some embodiments, the oxidant is a mixture of potassium permanganate, sulfuric acid, and hypophosphorous acid.

In some embodiments, carbon sources are exposed to an oxidant by sonicating the carbon source in presence of the oxidant. In some embodiments, the exposing includes heating the carbon source in presence of the oxidant. In some embodiments, the heating occurs at temperatures of at least about 100° C.

The use of additional methods of forming graphene quantum dots can also be envisioned. For instance, additional methods of forming graphene quantum dots are disclosed in Applicants' co-pending International Patent Application No. PCT/US2014/036604. Additional suitable methods of making graphene quantum dots are also disclosed in the following references by Applicants: ACS Appl. Mater. Interfaces 2015, 7, 7041-7048; and Nature Commun. 2013, 4:2943, 1-6.

Association of Graphene Quantum Dots with Polymer Components

The methods of the present can result in the association of graphene quantum dots with polymer components in various manners. As such, the polymer composites of the present disclosure can contain various types of associations between graphene quantum dots and polymers. For instance, in some embodiments, the graphene quantum dots of the present disclosure become associated with polymer components and polymers through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof. In some embodiments, the graphene quantum dots of the present disclosure become associated with polymer components and polymers through hydrogen bonding interactions. Additional modes of association can also be envisioned.

Tuning the Emission Wavelength of the Polymer Composite

In some embodiments, the methods of the present disclosure also include a step of tuning the emission wavelength of the formed polymer composites. In some embodiments, the tuning step can include, without limitation, selecting the type of graphene quantum dots, selecting the sizes of the graphene quantum dots, enhancing the quantum yield of the graphene quantum dots, and combinations thereof.

In some embodiments, the tuning step includes enhancing the quantum yield of the graphene quantum dots. In some embodiments, the enhancing of the quantum yield of the graphene quantum dots occurs by at least one of hydrothermal treatment of the graphene quantum dots, treatment of the graphene quantum dots with one or more bases, treatment of the graphene quantum dots with one or more hydroxides, treatment of the graphene quantum dots with one or more dopants, and combinations thereof.

In some embodiments, the tuning step includes selecting the sizes of the graphene quantum dots. For instance, in some embodiments, graphene quantum dots with a size having a desired emission wavelength range can be selected. In some embodiments, such selection can result in the formation of polymer composites that contain the same emission wavelength range. In some embodiments, graphene quantum dots with different sizes and different emission wavelength ranges can be selected. In some embodiments, such selection can result in the formation of polymer composites with various emission wavelength ranges and various colors.

Polymer Composites

The methods of the present disclosure can be utilized to form various types of polymer composites. Further embodiments of the present disclosure pertain to polymer composites that are formed by the methods of the present disclosure. In some embodiments, the polymer composites of the present disclosure include a polymer and graphene quantum dots. Suitable polymers and graphene quantum dots were described previously. In some embodiments, the polymer is in the form of a polymer matrix. In some embodiments, the graphene quantum dots are homogenously dispersed within the polymer matrix. In some embodiments, the graphene quantum dots are in non-aggregated form within the polymer composites. As also described previously, the polymers and graphene quantum dots can be associated with one another through various types of interactions.

The polymer composites of the present disclosure can include various amounts of graphene quantum dots. For instance, in some embodiments, the graphene quantum dots constitute from about 1% to about 25% of the polymer composite by weight. In some embodiments, the graphene quantum dots constitute from about 1% to about 15% of the polymer composite by weight. In some embodiments, the graphene quantum dots constitute from about 1% to about 10% of the polymer composite by weight. In some embodiments, the graphene quantum dots constitute about 10% of the polymer composite by weight. In some embodiments, the graphene quantum dots constitute less than about 10% of the polymer composite by weight. In some embodiments, the graphene quantum dots constitute from about 5% to about 10% of the polymer composite by weight. In some embodiments, the graphene quantum dots constitute from about 5% to about 7% of the polymer composite by weight. In some embodiments, the graphene quantum dots constitute from about 1% to about 5% of the polymer composite by weight. In some embodiments, the graphene quantum dots constitute from about 1% to about 3% of the polymer composite by weight.

In some embodiments, the graphene quantum dots constitute about 1% of the polymer composite by weight. In some embodiments, the graphene quantum dots constitute about 2% of the polymer composite by weight. In some embodiments, the graphene quantum dots constitute about 3% of the polymer composite by weight. In some embodiments, the graphene quantum dots constitute about 5% of the polymer composite by weight. In some embodiments, the graphene quantum dots constitute about 7% of the polymer composite by weight. In some embodiments, the graphene quantum dots constitute about 15% of the polymer composite by weight. In some embodiments, the graphene quantum dots constitute about 20% of the polymer composite by weight. In some embodiments, the graphene quantum dots constitute about 25% of the polymer composite by weight.

In some embodiments, the polymer composites of the present disclosure may lack any solvents from a reaction mixture. In some embodiments, the polymer composites of the present disclosure can have a residual solvent content. For instance, in some embodiments, the polymer composites of the present disclosure have a residual solvent content that ranges from about 1% to about 20%. In some embodiments, the polymer composites of the present disclosure have a residual solvent content that ranges from about 1% to about 10%. In some embodiments, the polymer composites of the present disclosure have a residual solvent content that ranges from about 1% to about 5%.

The polymer composites of the present disclosure can also have various properties. For instance, in some embodiments, the polymer composites of the present disclosure are fluorescent. In some embodiments, the polymer composites of the present disclosure have fluorescence intensity units that range from about 1,000 arbitrary units to about 900,000 arbitrary units. In some embodiments, the polymer composites of the present disclosure have fluorescence intensity units that range from about 2,000 arbitrary units to about 600,000 arbitrary units. In some embodiments, the polymer composites of the present disclosure have fluorescence intensity units that range from about 4,000 arbitrary units to about 500,000 arbitrary units. In some embodiments, the arbitrary units may represent molecules of equivalent soluble fluorochrome (MESF).

In some embodiments, the polymer composites of the present disclosure are optically transparent. For instance, in some embodiments, the polymer composites of the present disclosure have an optical transparency that ranges from about 30% to about 100%. In some embodiments, the polymer composites of the present disclosure have an optical transparency that ranges from about 50% to about 100%. In some embodiments, the polymer composites of the present disclosure have an optical transparency that ranges from about 60% to about 100%. In some embodiments, the polymer composites of the present disclosure have an optical transparency that ranges from about 70% to about 100%. In some embodiments, the polymer composites of the present disclosure have an optical transparency of more than about 70%. In some embodiments, the polymer composites of the present disclosure have an optical transparency that ranges from about 75% to about 95%. In some embodiments, the polymer composites of the present disclosure have an optical transparency that ranges from about 30% to about 99%.

In some embodiments, the polymer composites of the present disclosure are rigid. In some embodiments, the polymer composites of the present disclosure are flexible. In some embodiments, the polymer composites of the present disclosure are in the form of a film, such as a thin film.

In some embodiments, the polymer composites of the present disclosure can be used in light emitting diodes. In some embodiments, the graphene quantum dots in the polymer composites of the present disclosure can be used to generate photosensitized white light from the light emitting diodes.

Advantages

The methods of the present disclosure provide scalable, cost-effective, and environmentally friendly methods of making various types of graphene quantum dot-polymer composites with tunable photoluminescent properties. For instance, in some embodiments, the methods of the present disclosure utilize commercially available polymers and graphene quantum dots (e.g., coal-derived or coke-derived graphene quantum dots). Furthermore, due to their low production cost, biodegradability, non-toxicity, and ability for large scale production (see, e.g., Small, 2015, 11, 1620-1636), the graphene quantum dots of the present disclosure can be successfully used as cost-effective and environmentally friendly alternatives to conventional inorganic quantum dots. Moreover, due to the high quantum yields and solubilities of graphene quantum dots, the polymer composites of the present disclosure can provide effective photoluminescent properties without the need to utilize significant amounts of graphene quantum dots.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Fluorescent Polymer Composite Films Containing Coal-Derived Graphene Quantum Dots

In this Example, Fluorescent polymer composite materials were prepared by casting from aqueous solutions. Polyvinyl alcohol (PVA) was used as a polymer matrix. Graphene quantum dots (GQDs) derived from coal were mixed with the polymer matrix. The coal-derived GQDs impart fluorescent properties to the polymer matrix, and the fabricated composite films exhibit solid state fluorescence. Optical, thermal and fluorescent properties of the PVA/GQD nanocomposites were studied. High optical transparency of the composite films (78 to 91%) and optimal dispersion of the nanoparticles are observed at GQD concentrations from 1 to 5 wt %. The maximum photoluminescence intensity was achieved at 10 wt % GQD content.

In this Example, PVA was chosen as a matrix polymer because of its hydrophilic properties, including solubility in water, high optical transparency, good chemical resistance, easy processability, and good film-forming properties. GQDs obtained from bituminous coal were used as filler particles for the PVA-based nanocomposites. Because of the natural abundance of polar functional at the edges of GQDs synthesized from coal, they were used in the polymer composites without additional surface modification.

Both PVA and GQD were dissolved in water. After casting from solution, the water was evaporated, leading to the film formation. Composites with 1-25 wt % GQD concentrations were prepared.

### Example 1.1. Materials

Poly(vinyl alcohol) (˜99% hydrolyzed, MW of 89000-98000, Sigma-Aldrich), bituminous coal (Fisher Scientific), sulfuric acid (95-98%, Sigma-Aldrich) and nitric acid (70%, Sigma-Aldrich) were used as received. Dialysis bags (Membrane Filtration Products, Inc. Product number 1-0150-45) were used to purify the GQDs.

### Example 1.2. GQD Synthesis

GQDs were synthesized from bituminous coal using an oxidative treatment in a mixture of sulfuric and nitric acid according to a previously reported procedure. See, e.g., Ye R. et al., Nat. Commun. 2013, 4:2943. Also see International Patent Application No. PCT/US2014/036604.

### Example 1.3. Fabrication of the Composite Films

PVA powder and various amounts of GQDs (from 10 mg for 1 wt % concentration to 250 mg for 25 wt % concentration) were dissolved in 20 mL of water using magnetic stirring and heating at 80° C. for 8 hours to completely dissolve the powdered polymer. The GQDs dissolved almost instantly. Additional bath sonication for 10 minutes was used to ensure good dispersion of GQDs. Thereafter, 3 mL of each PVA/GQD solution was placed into a Petri dish and dried under vacuum in a desiccator for 24 hours at room temperature. The film formation took place with the evaporation of water.

### Example 1.4. Characterization

Fourier transform infrared (FT-IR) spectra were acquired on a Nicolet FT-IR infrared microscope with an attenuated total reflectance (ATR) attachment. Transmission electron microscopy (TEM) observations of the GQDs and PVA/GQD composites were conducted using a JEOL1230 high contrast TEM. For the TEM imaging of the composite films, small droplets of PVA/GQD solutions were deposited on TEM grids and dried in a desiccator to form ultra-thin films transparent to the electron beam. High-resolution TEM (HR-TEM) images of the GQDs were collected using JEOL 2100 field emission gun TEM.

Ultraviolet-visible (UV/vis) spectra were recorded on a Shimadzu UV-2450 UV/vis spectrophotometer. Differential scanning calorimetry (DSC) analysis of the materials was performed using a DSC Q10 calorimeter (TA Instruments) at a 10° C./min heating rate in the temperature range of 25° C. to 250° C. followed by cooling at a 5° C./min rate to 25° C.

Thermogravimetric analysis (TGA) was performed on a TGA Q50 instrument (TA Instruments) at a heating rate of 10° C./min, from room temperature to 600° C. The experiments were carried out under an air atmosphere at a flow rate of 50 mL/min.

Photoluminescence spectroscopy measurements were conducted using a Jobin Yvon HORIBA NanoLog spectrofluorometer at a 345 nm excitation wavelength within a 370 to 550 nm excitation wavelength range.

### Example 1.5. Results and Discussion

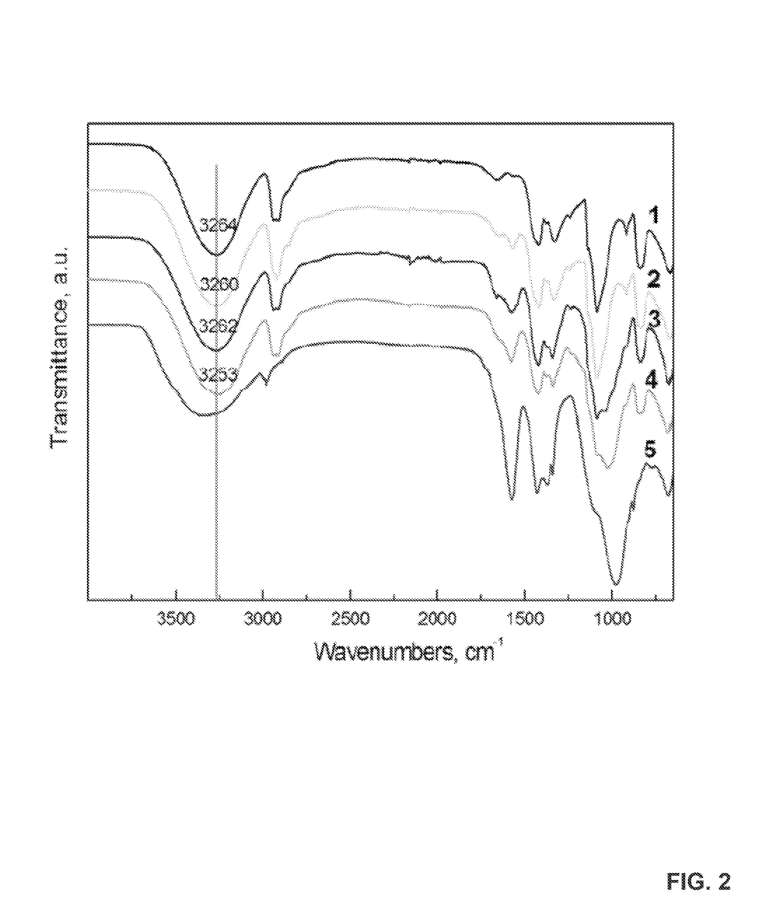

FT-IR spectra for the GQDs, PVA and PVA/GQD composites are shown in FIG. 2. The spectra for the pure PVA and PVA/GQD composites (at different GQD concentrations) are similar to the additive blends of PVA and GQDs. The intensity of the GQD peak increases with the increased GQD loading.

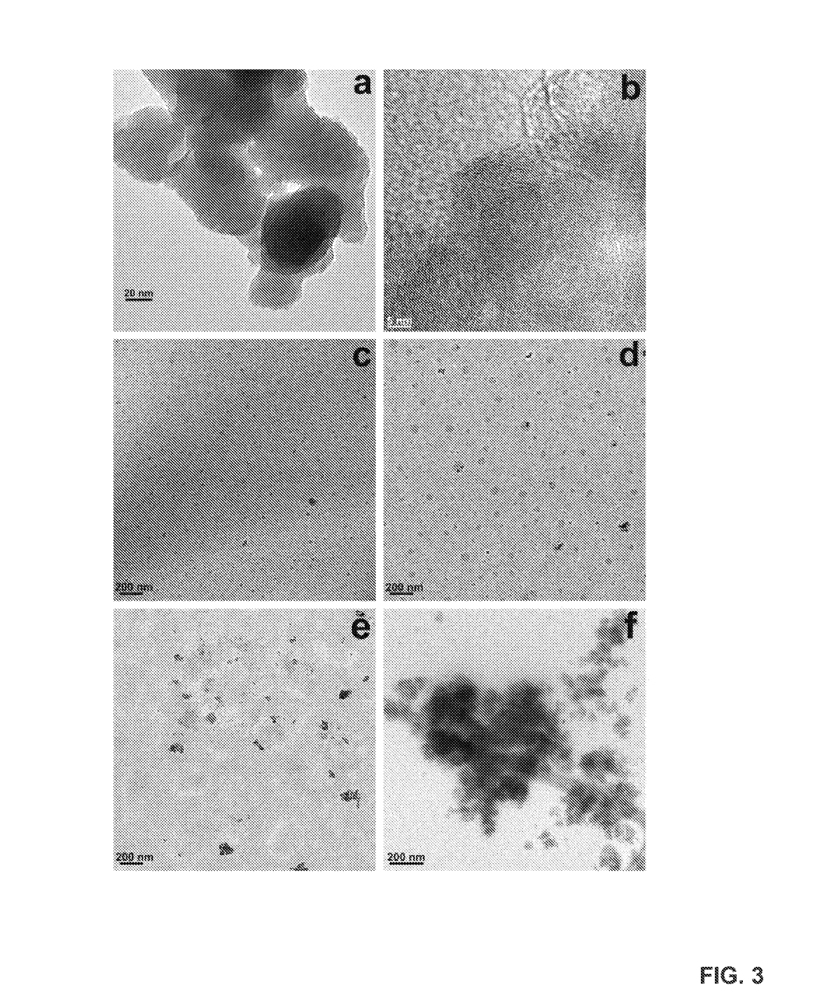

FIGS. 3A-B show TEM and HR-TEM images of the GQDs synthesized from bituminous coal. The GQDs have irregular spherical-like shapes with a typical size of 15 to 50 nm. FIGS. 3C-F show typical TEM images of the GQD distribution in the thin PVA/GQD composite films.

The images at lower loadings support the achievement of a homogeneous GQD dispersion in the polymer matrix. The composite with the lowest GQD loading (1 wt %) showed almost no aggregation of the filler nanoparticles. An increase in the GQD concentration, up to 5 to 7 wt %, leads to moderate particle aggregation, with typical cluster size below 100 nm. At GQD concentrations approaching 10 wt % and above, considerable nanoparticle agglomeration was observed (FIG. 3F) with a formation of loose agglomerates having dimensions of more than 500 nm. The GQDs demonstrate optimal dispersibility in the PVA matrix without any additional surface modification. This is a notable advantage of coal-derived GQDs over inorganic QDs that normally require surface treatment in order to prevent agglomeration.

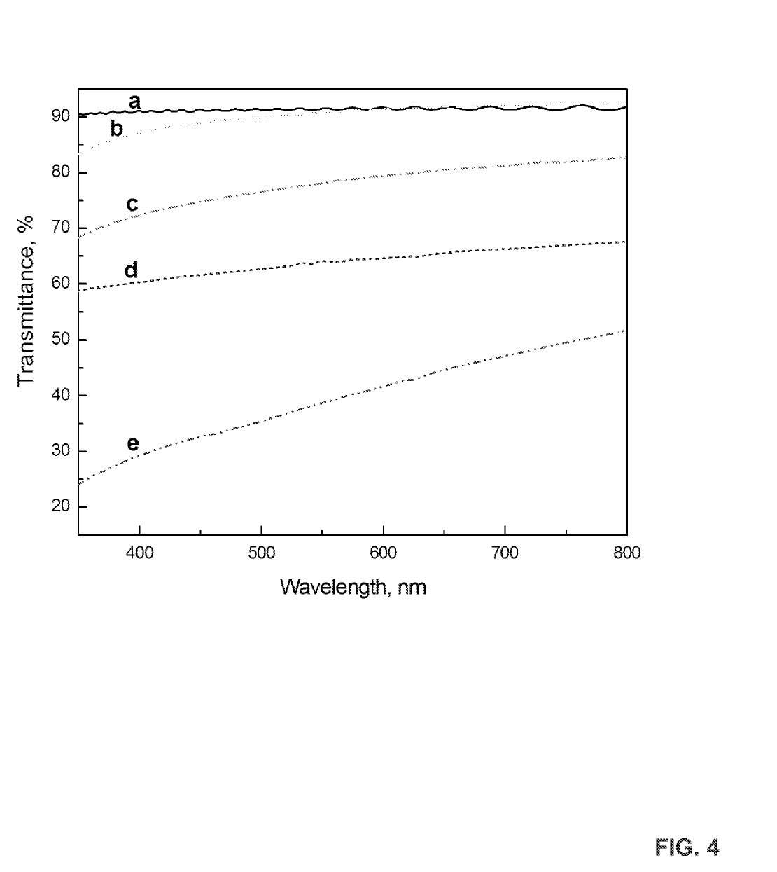

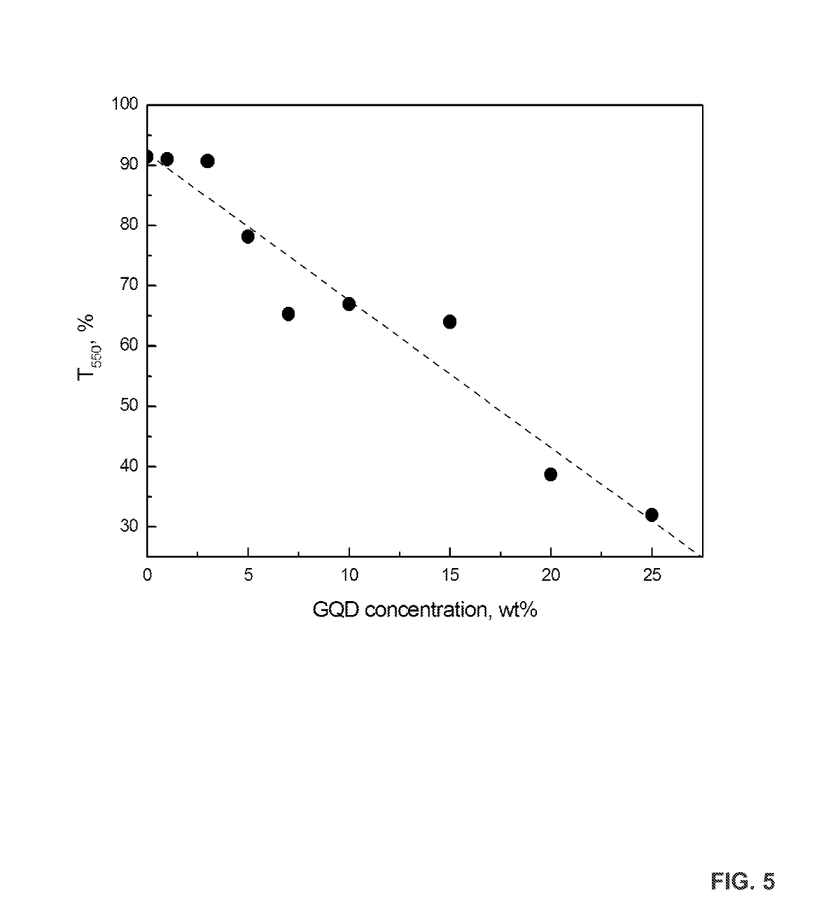

Information on the structure and optical properties of the composite films can be provided by UV/vis spectroscopy. FIG. 4 shows UV/vis spectra of the neat PVA and PVA/GQD films. The thickness of the analyzed film samples was ˜10 μm. The dependence of the film's optical transparency (light transmittance at 550 nm wavelength) on the GQD content is plotted in FIG. 5. Because of the fine nanoscale dispersion of the GQDs up to 3 wt % loadings, the composite films retain very high optical transparency (˜91%) that is on the same level as the baseline polymer (91.4%). Further increase in the GQD loading leads to nanoparticle agglomeration that is evidenced by the considerable drop in the optical transparency (to 78% and below) at GQD concentrations from 5 wt %; findings that are consistent with the TEM observations.

The film transparency is maintained at almost the same level (˜65%) in a wide range of the GQD concentrations from 7 to 15 wt %. Based on this data, the composites have comparable levels of nanoparticle agglomeration, near their volumetric saturation, at these filler loadings. The further drop in the optical transparency below 40% at 20 wt % concentration signifies a level of GQD agglomeration above the saturation point. Accordingly, based on these results, the best GQD concentration range for potential optoelectronic applications of the polymer/GQD composites in this Example is between 1 and 15 wt %.

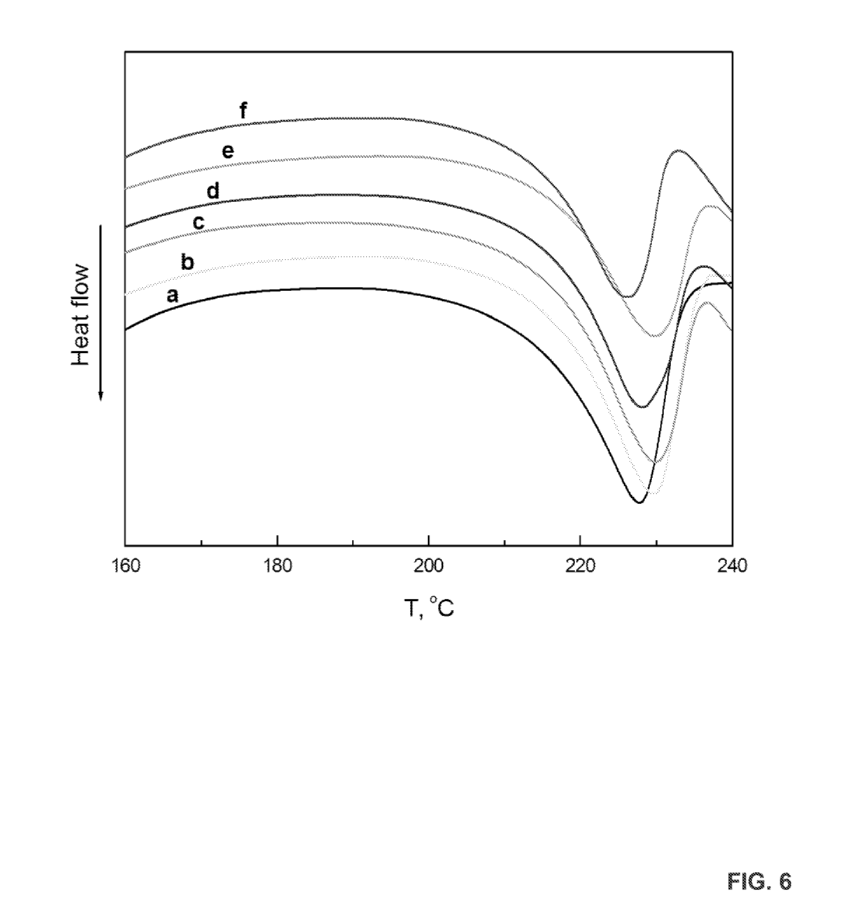

DSC thermograms (1^{st} heating cycles) for the PVA and PVA/GQD nanocomposites are shown in FIG. 6. Only small increases in the polymer melting peak temperature (Tₘ) from 227° C. for the neat PVA to 228 to 230° C. for the composites takes place upon the incorporation of 1 to 20 wt % of GQDs. The melting enthalpy (ΔHₘ) of the composites demonstrates a gradually declining trend with the increase in GQD loading (Table 1).

| | Tₘ, | ΔHₘ, | | T_{c}, |
|---|---|---|---|---|
| Material | ° C. | J/g | X_{c},* % | ° C. |
| PVA | 227 | 65.08 | 47.0 | 202 |
| PVA/GQD 3 wt % | 229 | 62.38 | 46.4 | 205 |
| PVA/GQD 5 wt % | 230 | 54.25 | 41.2 | 206 |
| PVA/GQD 7 wt % | 230 | 41.69 | 32.3 | 197 |
| PVA/GQD 15 wt % | 228 | 37.47 | 31.8 | 204 |
| PVA/GQD 20 wt % | 230 | 35.49 | 32.0 | 202 |
| PVA/GQD 25 wt % | 226 | 37.12 | 35.7 | 195 |

*X_{c} calculated from the ratio ΔHₘ/ΔH₀, where ΔHₘ is the measured and the ΔH₀ is 100% crystalline melting enthalpy of PVA, respectively. Here ΔH₀ is taken as 138.6 J/g [23], ΔHₘ is normalized to the PVA content in the material.

Table 1 provides a summary of the thermal properties of the PVA/GQD composites.

Thus, GQDs reduce the crystallinity degree (X_{c}) of the host polymer. Without being bound by theory, it is envisioned that this effect can be attributed to strong molecular interactions, such as hydrogen bonding, between the system components as previously reported for the structurally similar PVA/reduced graphene oxide composites.

Without being bound by theory, it is envisioned that the broad band between 3000 and 3500 cm⁻¹ in the FT-IR spectra (FIG. 2) involving the strong hydroxyl band for free and hydrogen-bonded alcohols, can indicate hydrogen bonding, possibly between the polymer matrix and nanoparticle filler. Without being bond by further theory, it is envisioned that the decrease of the polymer crystallinity may have been caused by a combination of several factors, primarily steric effects and structural disorders induced by the incorporation of GQDs, with some influence from the hydrogen bonding.

Crystallization temperature (T_{c}) of the PVA slightly increases by 3 to 4° C. at GQD concentrations of 3 to 5 wt % (Table 1), showing very small nucleation effect induced by the filler nanoparticles. The further T_{c} decrease at higher GQD loadings is apparently caused by the nanoparticle agglomeration at these concentrations.

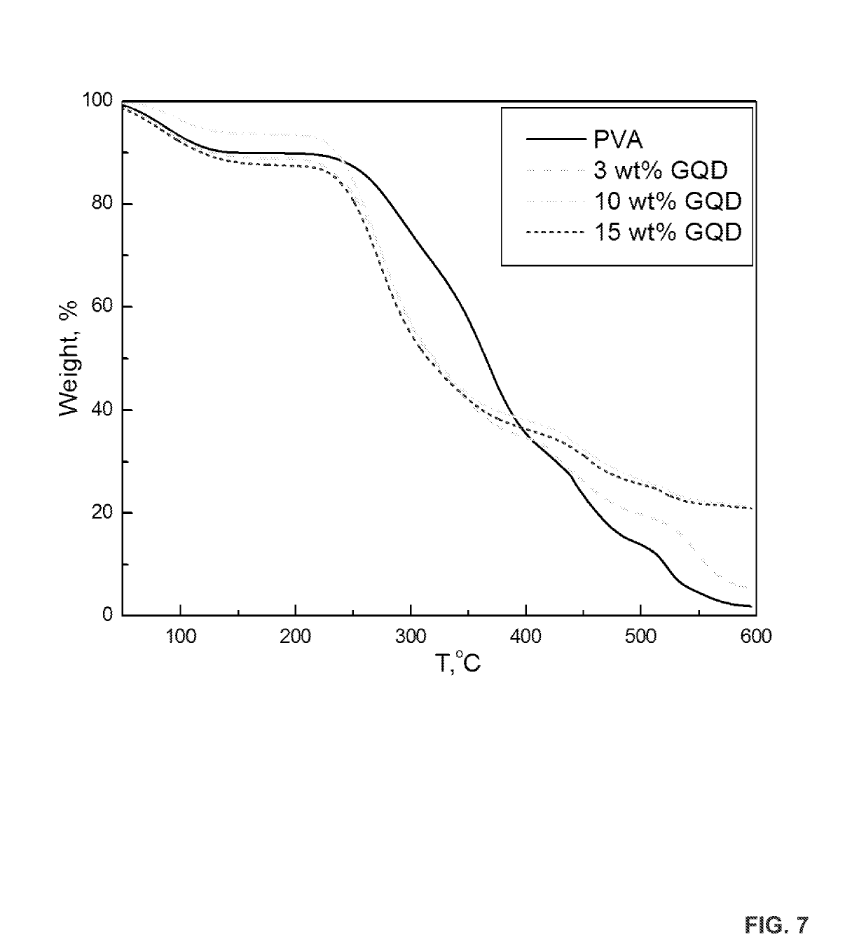

Based on the TGA data (FIG. 7), the residual water content in the PVA and PVA/GQD films is ˜5 to 10 wt %; the removal of water from the films takes place between 50° C. and 150° C.

As seen from FIG. 7, the incorporation of GQDs in the PVA matrix changes the decomposition behavior of the polymer. The maximum weight loss temperature decreases from ˜366° C. for PVA to ˜280° C. for the composites. Without being bound by theory, it is envisioned that this observation provides evidence for the catalytic effect of GQDs on the polymer decomposition process. Moreover, the amount of residue formed in the process of PVA decomposition increases with the addition of GQDs. While the neat PVA decomposes almost completely before 600° C., considerable amounts of black carbonized residues (up to 20%) remain after the composites burn out. Formation of these carbonized residues can be explained as a result of GQD thermal reduction by the polymer, a known process for graphene oxide reduction to graphene. GQDs are chemically similar to graphene oxide and the same effect could be operating here in the case of PVA/GQD nanocomposites.

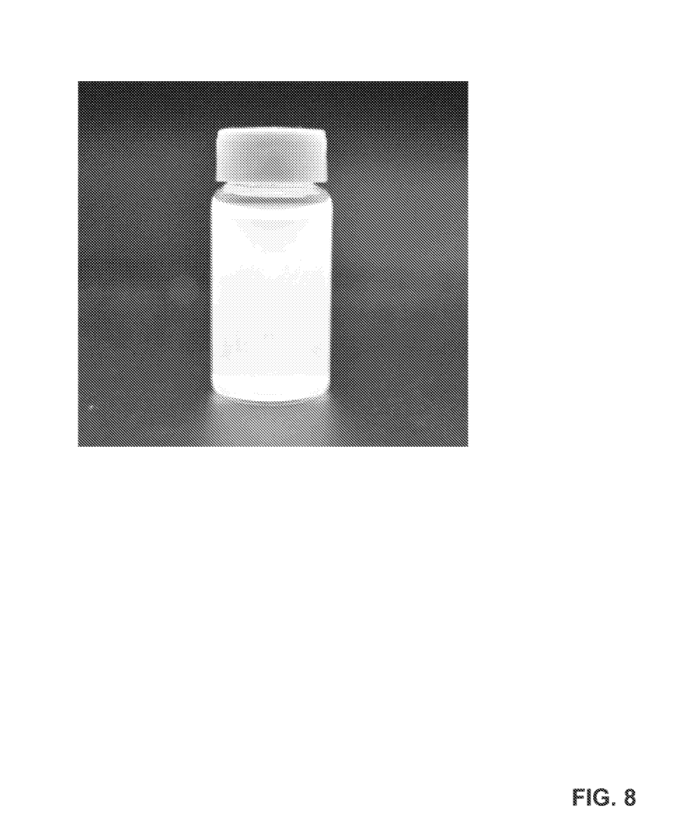

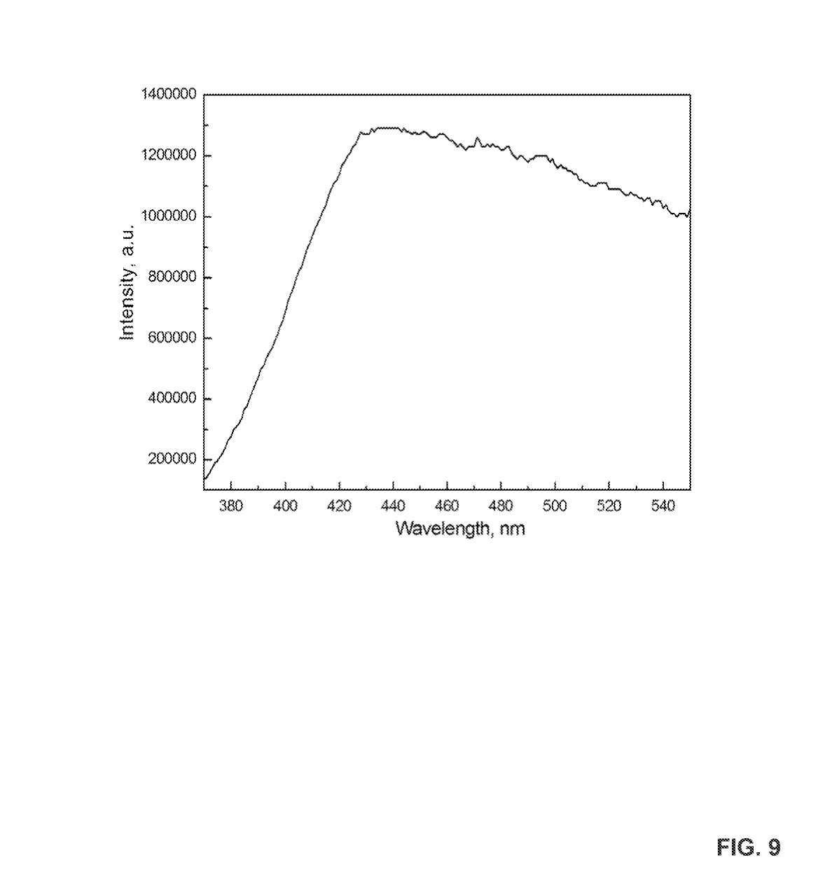

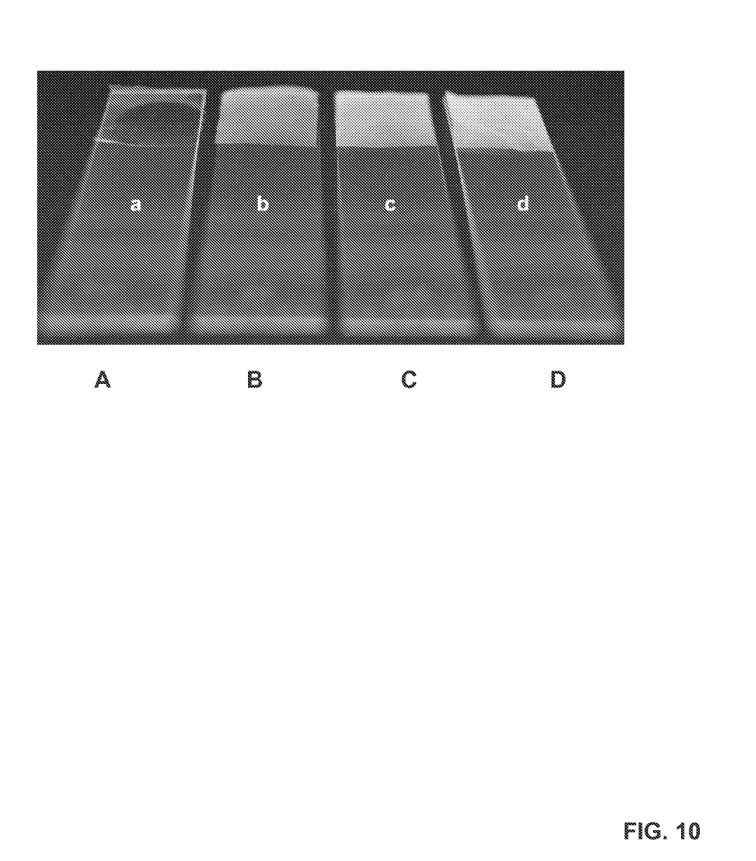

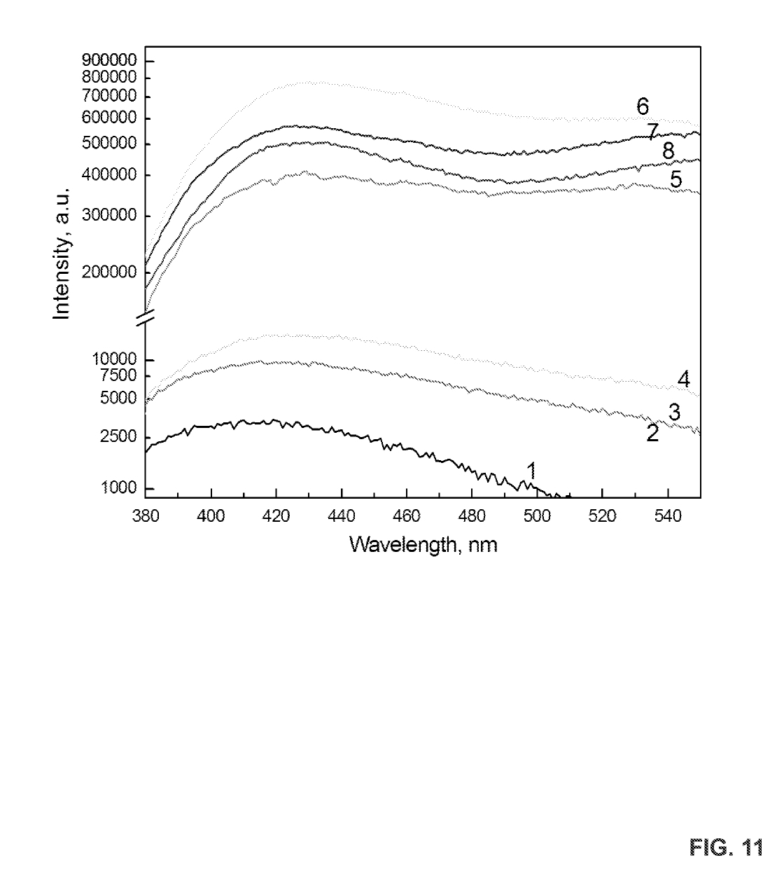

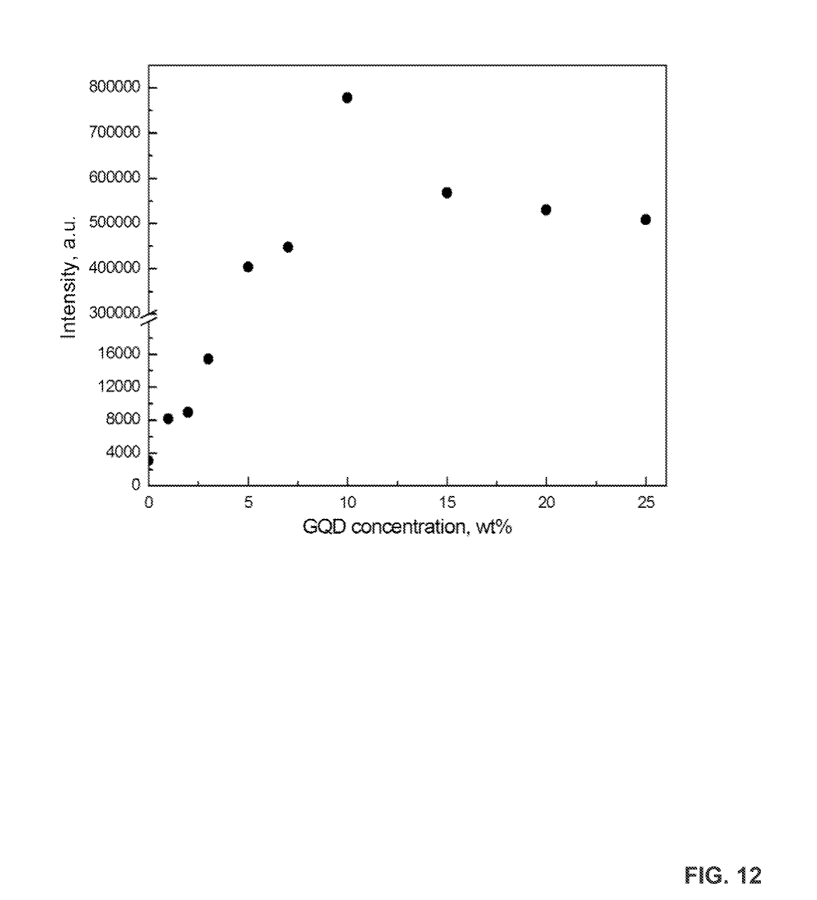

FIG. 8 demonstrates fluorescence emitted by dilute aqueous solution of GQDs (0.125 mg/ml) under UV light; strong bright fluorescence is noted. The corresponding solution state photoluminescence spectrum for GQDs is shown in FIG. 9. It was found that the incorporation of GQDs in the PVA matrix imparts fluorescent properties to the resultant composites. The fluorescent behavior of the PVA/GQD composite films was first noted in a photograph (FIG. 10) taken under a UV lamp. An increase in the composite emission intensity with GQD loading is evidenced by the increase of the film brightness in FIGS. 10B-D. The color of the emitted light appears to be white. The PVA film (FIG. 10A) shows no emission. In order to quantify the fluorescent properties of the PVA/GQD nanocomposites, photoluminescent spectroscopy measurements in a solid state were done; the corresponding spectra are shown in FIG. 11. The photoluminescence peak intensities (at 430 nm wavelength) of the films vs the corresponding GQD concentrations are plotted in FIG. 12. According to this data, the photoluminescence intensity of the composites is concentration dependent and progressively grows with the increase of GQD content within the 1 to 10 wt % concentration range. A large increase in the photoluminescence intensity (26-fold) was observed between 3 and 5 wt % GQD loading. This suggests that partial agglomeration of GQDs observed at this concentration could be somewhat beneficial for the material's fluorescent properties. The maximum intensity was observed at 10 wt % loading, at which the saturation point was apparently reached. At higher GQD concentrations (15 to 25 wt %), some decrease of the photoluminescence intensity occurs that can be explained by the considerable nanoparticle agglomeration. These results correlate well with the previously described UV/vis data. Accordingly, in order to achieve the maximum output efficiency of the PVA/GQD composites in terms of their fluorescence level, the recommended concentration range of GQDs is 5 to 10 wt % in this Example.

In conclusion, the coal-derived GQDs have been successfully blended with PVA using a simple and environmentally friendly solution method with water as the solvent. The GQDs show optimal dispersibility without any additional surface modification. This is an important advantage of the coal GQDs over inorganic QDs that typically require modification to be efficiently dispersed in a polymer phase. Fluorescence was successfully achieved in PVA/GQD composites and the materials exhibited concentration-dependent behavior, with fluorescence intensity progressively increasing as the GQD content increased; the fluorescence reached its maximum at 10 wt % loading.

### Example 2. Preparation of Octylamide-Functionalized Graphene Quantum Dots for Use in Polymer Composites

This Example provides a method of making octylamide-functionalized GQDs for use in polymer composites. The GQDs were prepared by dispersing 2.5 g of anthracite in 160 mL of 95-98% H₂SO₄ and 86 mL of 70% HNO₃ and heating the mixture to 80° C. for 24 hours while stirring. The solution was cooled to room temperature and diluted to three times its value with ice water and was then neutralized with a saturated aqueous solution of Na₂CO₃. The GQD solution was purified using cross-flow ultrafiltration with a 3 kDa column under 8 psi transmembrane pressure. Dry GQDs were obtained by rotary evaporation under reduced pressure.

Octylamide-functionalized GQDs were synthesized by dissolving 50 mg of the as-prepared GQDs in 10 mL of DI H₂O and 15 mL of THF. Next, 33 mg of DMAP and 1 mL of octylamine were added to the solution followed by 1.1 g of DCC. The solution was heated to 40° C. and stirred under Ar gas for 24 hours

Next, the solution of octylamide-functionalized GQDs was diluted three times its volume with diethyl ether and centrifuged at 4000 rpm for 30 minutes. The ether was decanted, and the precipitated GQDs were dissolved in DCM and dried using rotary evaporation under reduced pressure.

### Example 3. Preparation of Polymer Composites from Graphene Quantum Dots and Polymer Precursors

In this Example, GQD-polymer composites were prepared by mixing GQDs with polymer precursors. The polymer precursors were then polymerized in the presence of the GQDs.

Tetradecylated graphene quantum dots derived from anthracite (C₁₄-aGQDs) were obtained by amide formation between anthracite-derived GQDs and 1-aminotetradecane. The monomers used to make the composites were styrene and methyl methacrylate. Each monomer was passed through neutral alumina to remove the inhibitors. Azobis(isobutryl)nitrile (AIBN) was recrystallized from methanol. The monomer, 1 wt % C14-aGQDs, and 1 wt % AIBN were placed in a scintillation vial, sonicated for 1 minute, and stirred for 30 minutes to ensure dispersion. The solution was heated to 75° C. for 5 hours under nitrogen gas without stirring. A monolith was obtained for each composite and observed under a UV lamp.

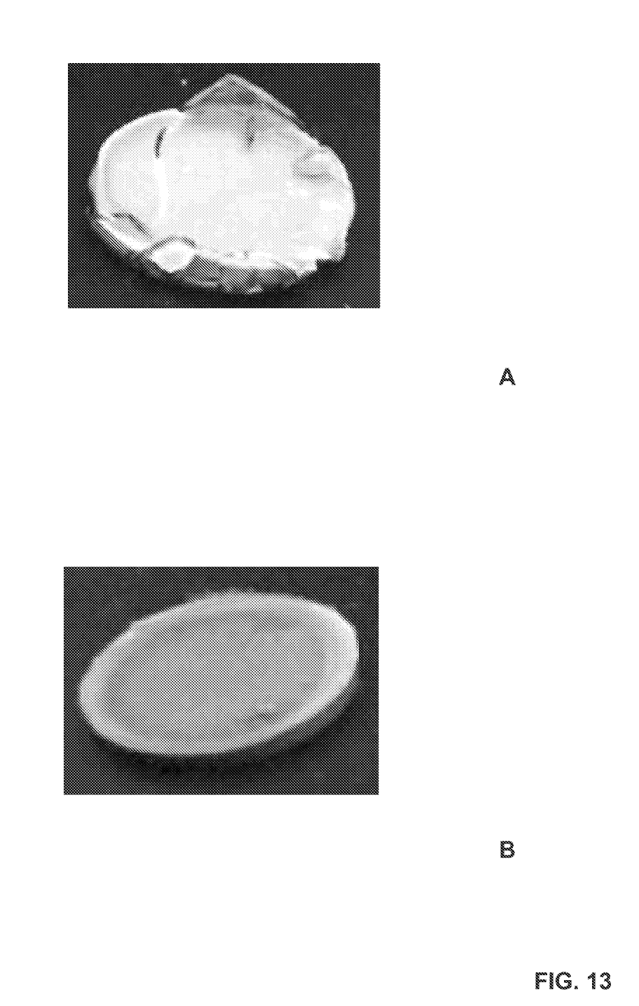

The C₁₄-aGQD/polystyrene soft monolithic composite was placed under a UV lamp and it showed orange-yellow emission of moderate visual intensity (FIG. 13A). The polystyrene could be made more rigid by the addition of 2 wt % divinylbenzene to the polymerization mixture.

The C₁₄-aGQD/poly(methyl methacrylate) monolithic composite formed as a solid resin. When placed under a UV lamp, an orange-yellow emission of moderate intensity was observed (FIG. 13B).

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of forming a polymer composite comprising polymers and graphene quantum dots, said method comprising:
mixing a polymer component with graphene quantum dots, wherein the polymer component is selected from the group consisting of polymers, polymer precursors, and combinations thereof.

2. The method of claim 1, wherein the mixing comprises at least one of stirring, magnetic stirring, sonication, agitation, centrifugation, blending, extruding, masticating, heating, solution casting, molding, pressing, and combinations thereof.

3. The method of claim 1, wherein the mixing results in the association of the graphene quantum dots with the polymer component.

4. The method of claim 3, wherein the graphene quantum dots become associated with the polymer component through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

5. The method of claim 1, wherein the mixing occurs in a solvent.

6. The method of claim 5, wherein the method further comprises a step of removing at least a portion of the solvent.

7. The method of claim 1, wherein the mixing occurs in the absence of a solvent.

8. The method of claim 1, wherein the polymer component comprises polymers.

9. The method of claim 8, wherein the polymers comprise water soluble polymers.

10. The method of claim 8, wherein the polymers comprise water insoluble polymers.

11. The method of claim 8, wherein the polymers are selected from the group consisting of vinyl polymers, condensation polymers, chain-growth polymers, step-growth polymers, polyacrylamides, polyacrylates, polystyrene, polybutadiene, polyacrylonitrile, polysaccharides, polyacrylic acid, polyesters, polyamides, polyurethanes, polyimides, nylons, polyvinyl alcohol, polyethylene oxide, polypropylene oxides, polyethylene glycol, poly(ethylene terephthalate), poly(methyl methacrylate), derivatives thereof, and combinations thereof.

12. The method of claim 1, wherein the polymers are in the form of a polymer matrix, and wherein the graphene quantum dots are homogenously dispersed within the polymer matrix.

13. The method of claim 1, wherein the polymer component comprises polymer precursors, and wherein the polymer precursors polymerize to form polymers.

14. The method of claim 13, wherein the polymer precursors polymerize during the mixing step.

15. The method of claim 13, further comprising a step of polymerizing the polymer precursors.

16. The method of claim 15, wherein the polymerizing occurs by exposing the polymer precursors to a polymerizing agent.

17. The method of claim 13, wherein the polymer precursors are selected from the group consisting of vinyl monomers, acrylamides, acrylates, styrene, butadiene, acrylonitrile, saccharides, acrylic acid, esters, amides, urethanes, imides, vinyl alcohol, ethylene oxide, propylene oxide, ethylene glycol, ethylene terephthalate, methyl methacrylate, derivatives thereof, and combinations thereof.

18. The method of claim 1, wherein the graphene quantum dots are selected from the group consisting of unfunctionalized graphene quantum dots, functionalized graphene quantum dots, pristine graphene quantum dots, and combinations thereof.

19. The method of claim 1, wherein the graphene quantum dots comprise functionalized graphene quantum dots.

20. The method of claim 19, wherein the functionalized graphene quantum dots are functionalized with one or more functional groups selected from the group consisting of oxygen groups, carboxyl groups, carbonyl groups, amorphous carbon, hydroxyl groups, alkyl groups, aryl groups, esters, amines, amides, polymers, poly(propylene oxide), and combinations thereof.

21. The method of claim 19, wherein the functionalized graphene quantum dots comprise edge-functionalized graphene quantum dots.

22. The method of claim 1, wherein the graphene quantum dots comprise pristine graphene quantum dots.

23. The method of claim 1, wherein the graphene quantum dots have diameters that range from about 1 nm to about 100 nm.

24. The method of claim 1, wherein the graphene quantum dots are selected from the group consisting of coal-derived graphene quantum dots, coke-derived graphene quantum dots, and combinations thereof.

25. The method of claim 1, wherein the graphene quantum dots comprise coal-derived graphene quantum dots.

26. The method of claim 25, wherein the coal is selected from the group consisting of anthracite, bituminous coal, sub-bituminous coal, metamorphically altered bituminous coal, asphaltenes, asphalt, peat, lignite, steam coal, petrified oil, carbon black, activated carbon, and combinations thereof.

27. The method of claim 1, further comprising a step of tuning the emission wavelength of the polymer composite.

28. The method of claim 27, wherein the tuning comprises at least one of selecting the type of graphene quantum dots, selecting the sizes of the graphene quantum dots, enhancing the quantum yield of the graphene quantum dots, and combinations thereof.

29. The method of claim 1, wherein the polymer composite is fluorescent.

30. The method of claim 29, wherein the polymer composite has fluorescence intensity units that range from about 1,000 arbitrary units to about 900,000 arbitrary units.

31. The method of claim 1, wherein the polymer composite is optically transparent.

32. The method of claim 31, wherein the polymer composite has an optical transparency ranging from about 30% to about 99%.

33. The method of claim 1, wherein the polymer composite is in the form of a film.

34. The method of claim 1, wherein the graphene quantum dots constitute from about 1% to about 15% of the polymer composite by weight.

35. The method of claim 1, wherein the graphene quantum dots constitute from about 1% to about 5% of the polymer composite by weight.

36. The method of claim 1, wherein the polymer composite is utilized in light emitting diodes.

37. The method of claim 36, wherein the graphene quantum dots in the polymer composite are utilized to generate photogenerated white light from the light emitting diodes.

38. A polymer composite comprising:
(a) a polymer; and
(b) graphene quantum dots.

39. The polymer composite of claim 38, wherein the graphene quantum dots are associated with the polymer.

40. The polymer composite of claim 39, wherein the graphene quantum dots are associated with the polymer through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

41. The polymer composite of claim 38, wherein the polymer comprises water soluble polymers.

42. The polymer composite of claim 38, wherein the polymer comprises water insoluble polymers.

43. The polymer composite of claim 38, wherein the polymer is selected from the group consisting of vinyl polymers, condensation polymers, chain-growth polymers, step-growth polymers, polyacrylamides, polyacrylates, polystyrene, polybutadiene, polyacrylonitrile, polysaccharides, polyacrylic acid, polyesters, polyamides, polyurethanes, polyimides, nylons, polyvinyl alcohol, polyethylene oxide, polypropylene oxides, polyethylene glycol, poly(ethylene terephthalate), poly(methyl methacrylate), derivatives thereof, and combinations thereof.

44. The polymer composite of claim 38, wherein the polymer is in the form of a polymer matrix, and wherein the graphene quantum dots are homogenously dispersed within the polymer matrix.

45. The polymer composite of claim 38, wherein the graphene quantum dots are selected from the group consisting of unfunctionalized graphene quantum dots, functionalized graphene quantum dots, pristine graphene quantum dots, and combinations thereof.

46. The polymer composite of claim 38, wherein the graphene quantum dots comprise functionalized graphene quantum dots.

47. The polymer composite of claim 46, wherein the functionalized graphene quantum dots are functionalized with one or more functional groups selected from the group consisting of oxygen groups, carboxyl groups, carbonyl groups, amorphous carbon, hydroxyl groups, alkyl groups, aryl groups, esters, amines, amides, polymers, poly(propylene oxide), and combinations thereof.

48. The polymer composite of claim 46, wherein the functionalized graphene quantum dots comprise edge-functionalized graphene quantum dots.

49. The polymer composite of claim 38, wherein the graphene quantum dots comprise pristine graphene quantum dots.

50. The polymer composite of claim 38, wherein the graphene quantum dots have diameters that range from about 1 nm to about 100 nm.

51. The polymer composite of claim 38, wherein the graphene quantum dots are selected from the group consisting of coal-derived graphene quantum dots, coke-derived graphene quantum dots, and combinations thereof.

52. The polymer composite of claim 38, wherein the graphene quantum dots comprise coal-derived graphene quantum dots.

53. The polymer composite of claim 38, wherein the polymer composite is fluorescent.

54. The polymer composite of claim 53, wherein the polymer composite has fluorescence intensity units that range from about 1,000 arbitrary units to about 900,000 arbitrary units.

55. The polymer composite of claim 38, wherein the polymer composite is optically transparent.

56. The polymer composite of claim 55, wherein the polymer composite has an optical transparency ranging from about 30% to about 99%.

57. The polymer composite of claim 38, wherein the polymer composite is in the form of a film.

58. The polymer composite of claim 38, wherein the graphene quantum dots constitute from about 1% to about 15% of the polymer composite by weight.

59. The polymer composite of claim 38, wherein the graphene quantum dots constitute from about 1% to about 5% of the polymer composite by weight.

60. The polymer composite of claim 38, wherein the polymer composite is utilized in light emitting diodes.

61. The polymer composite of claim 60, wherein the graphene quantum dots in the polymer composite are utilized to generate photogenerated white light from the light emitting diodes.
